(19) United States
(12) Patent Application Publication
(10) Pub. No.: US 2023/0011351 A1
(43) Pub. Date: Jan. 12, 2023

(54) SYSTEM AND METHOD FOR GENERATING A DATA TABLE FOR A PROVIDER

(71) Applicant: Hammel Companies Inc., Pittsburgh, PA (US)

(72) Inventor: Joseph Charles Dohrn, Woodland Park, CO (US)

(73) Assignee: Hammel Companies Inc., Pittsburgh, PA (US)

(21) Appl. No.: 17/371,990

(22) Filed: Jul. 9, 2021

(51) Int. Cl. G06Q 10/06; G06N 20/00

(52) U.S. Cl. CPC G06Q 10/06311; G06N 20/00

(57) ABSTRACT

A system for generating a data table of transports for a provider includes a computing device configured to receive a carrier request on a server, wherein the carrier request includes a transport datum of at least one transport. The computing device is configured to generate a transport optimizer. The transport optimizer provides a transport request as a function of the carrier request and provider resource datum. The computing device is configured to receive an electronic acknowledgement from a provider, wherein the electronic acknowledgement includes an electronic communication from a computing device of a provider acknowledging the transport time is confirmed by the provider. The computing device is configured to update a provider data table as a function of the electronic acknowledgement, wherein the provider data table includes a table of confirmed transports and resource status datums for a provider.

### FIELD OF THE INVENTION

The present invention generally relates to the field of transport scheduling and logistics management for a provider. In particular, the present invention is directed to methods and systems for generating a data table of transports for a provider.

### BACKGROUND

Modern providers have many transports that need to be tracked and the providers need to allocate resources for the transports accordingly. Current systems for tracking transports are not time efficient and are prone to human error.

### SUMMARY OF THE DISCLOSURE

In an aspect, a system for generating a data table of transports for a provider is disclosed. The system includes a computing device. The computing device is configured to receive a carrier request on a server. The carrier request includes a transport datum of at least one transport. The computing device is configured to generate a transport optimizer. The transport optimizer is configured to output a transport request. The transport request includes a transport time corresponding to the carrier request. The transport request is a function of the carrier request and provider resource datum. Generating the transport optimizer includes receiving training data. The training data includes a plurality of transport data and provider resource data. Generating the transport optimizer includes training the transport optimizer using the training data and a machine-learning algorithm. The computing device is configured to output the transport request as a function of the transport optimizer and the carrier request. The computing device is configured to receive an electronic acknowledgement from a provider. The electronic acknowledgement includes an electronic communication from a computing device of a provider acknowledging the transport time is confirmed by the provider. The computing device is configured to update a provider data table as a function of the electronic acknowledgement. The provider data table includes a table of confirmed transports and resource status datums for a provider.

In an aspect, a method for generating a data table of transports for a provider is disclosed. The method includes receiving a carrier request on a server of a computing device. The carrier request includes a transport datum of at least one transport. The method includes generating a transport optimizer on the computing device. The transport optimizer includes a machine learning model. The machine learning model is trained by using training data including a plurality of transport datum and provider resource datum. The transport optimizer, responsive to training, provides a transport request as a function of the carrier request and provider resource datum. The transport request includes a transport time corresponding to the carrier request. The method includes receiving an electronic acknowledgement from a provider on the computing device. The electronic acknowledgement includes an electronic communication from a computer device of a provider acknowledging the transport time is confirmed by the provider. The method includes updating a provider data table as a function of the electronic acknowledgement on the computing device. The provider data table includes a table of confirmed transports and resource status datums for a provider.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of a system for generating a data table of transports for a provider;

FIG. 2 is an exemplary embodiment of an internal database;

FIG. 3 is a flowchart of a method of for generating a data table of transports for a provider;

FIG. 4 is a block diagram of a machine learning system; and

FIG. 5 is a block diagram of a computing system that can be used to implement any one or more of the methodologies disclosed herein and any one or more portions thereof.

### DETAILED DESCRIPTION

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims.

Described herein is a system for generating a data table of transports for a provider. In some embodiments, the system may include a computing device. The computing device may be configured to receive a carrier request on a server. In some embodiments, the server may be configured to communicate between a provider computing device and a carrier computing device. The carrier request may include a transport datum of at least one transport. The transport datum may include a ready datum of the at least one transport. In some embodiments, the transport datum may include transport times and transport destination. In some embodiments, the transport datum may include a datum of amount and measurements of a plurality of components included in the at least one transport. The computing device may be configured to generate a transport optimizer. The transport optimizer may be configured to output a transport request. The transport request may include a transport time corresponding to the carrier request. The transport request may include a function of the carrier request and provider resource datum. In some embodiments, the provider datum may include data of open time intervals for a plurality of transports. In some embodiments, the provider resource datum may include a plurality of open holding units for transport media of the provider. The transport optimizer may be configured to receive training data. The training data may include a plurality of transport data and provider resource data. The transport optimizer may be configured to be trained using the training data and a machine-learning algorithm. The computing device may be configured to output the transport request as a function of the transport optimizer and the carrier request. The computing device may be configured to receive an electronic acknowledgement from a provider. In some embodiments, the electronic acknowledgement of the provider may include a verification datum. The electronic acknowledgement may include an electronic communication from a computing device of a provider. The electronic communication may include a confirmation that the transport time is accepted by the provider. The computing device may be configured to update a provider data table. The provider data table may be updated as a function of the electronic acknowledgement. The provider data table may include a table of confirmed transports and resource status datums of a provider.

Described herein is a method for generating a data table of transports for a provider. In some embodiments, the method may include receiving a carrier request on a server of a computing device. The carrier request may include a transport datum of at least one transport. In some embodiments, the datum of the at least one transport may include a ready datum of the at least one transport. In some embodiments, the datum of the at least one transport may include transport times and transport destinations. In some embodiments, the datum of the at least one transport may include a datum of amount and measurements of a plurality of components included in the at least one transport. The method may include generating a transport optimizer on the computing device. The transport optimizer may include a machine learning model. The machine learning model may be trained by using training data include a plurality of transport datum and provider resource datum. In some embodiments, the provider resource datum may include data of a plurality of holding units for transport mediums of the provider. In some embodiments, the provider datum may include data of measurements and weight of a plurality of transport mediums. The transport optimizer may be responsive to training and provide a transport request as a function of the carrier request and provider resource datum. The transport request may include a transport time corresponding to the carrier request. The method may include receiving an electronic acknowledgement from a provider on the computing device. In some embodiments, the electronic acknowledgement of the provider may include a verification datum. The electronic acknowledgement may include an electronic communication from a computing device of a provider. The electronic communication may include a acknowledging from the provider computing device that the transport time is confirmed. In some embodiments, the method may include updating a provider data table. The provider data table may be updated as a function of the electronic acknowledgment on the computing device. The provider data table may include a table of confirmed transports and resource status datums for a provider.

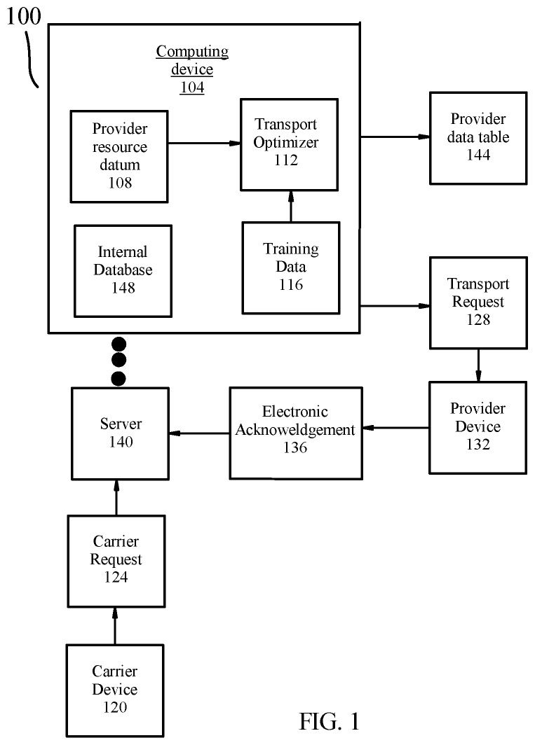

Referring now to FIG. 1, an exemplary embodiment of a system 100 for generating a data table for a provider is illustrated. System 100 includes a computing device 104. Computing device 104 may include any computing device as described in this disclosure, including without limitation a microcontroller, microprocessor, digital signal processor (DSP) and/or system on a chip (SoC) as described in this disclosure. Computing device 104 may include, be included in, and/or communicate with a mobile device such as a mobile telephone or smartphone. Computing device 104 may include a single computing device operating independently, or may include two or more computing devices operating in concert, in parallel, sequentially or the like; two or more computing devices may be included together in a single computing device or in two or more computing devices. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 104 may include but is not limited to, for example, a computing device or cluster of computing devices in a first location and a second computing device or cluster of computing devices in a second location. Computing device 104 may include one or more computing devices dedicated to data storage, security, distribution of traffic for load balancing, and the like. Computing device 104 may distribute one or more computing tasks as described below across a plurality of computing devices of computing device 104, which may operate in parallel, in series, redundantly, or in any other manner used for distribution of tasks or memory between computing devices. Computing device 104 may be implemented using a “shared nothing” architecture in which data is cached at the worker, in an embodiment, this may enable scalability of system 100 and/or computing device 104.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 104 may store a provider resource datum 108. Provider resource datum 108 may include a plurality of data about a plurality of resources of a provider. Provider resource datum 108 may include a quantity of available transport units, transport items, and/or transport unit fuel. In some embodiments, provider resource datum 108 may include data of open time intervals for a plurality of transports. In some embodiments, provider resource datum 108 may include data of a plurality of open holding units for transport mediums of the provider. In some embodiments, provider resource datum 108 may include data of measurements and weight of a plurality of transport mediums. Provider resource datum 108 may be configured to communicate with internal database 148. Computing device 104 may be configured to be in communication with server 140. Server 140 may be configured to wirelessly communicate with a plurality of devices. Server 140 may include any computing device as described in the entirety of this disclosure. For example and without limitation, a computing device may include a microcontroller, microprocessor, digital signal processor (DSP) and/or system on a chip (SoC), as described in further detail below. A computing device may include, be included in, and/or communicate with a mobile device such as a mobile telephone or smartphone. Server 140 may include a single computing device operating independently, or may include two or more computing device operating in concert, in parallel, sequentially or the like; two or more computing devices may be included together in a single computing device or in two or more computing devices. Server 140 may communicate with one or more additional devices as described below in further detail via a network interface device. Network interface device may be utilized for connecting server 140 to one or more of a variety of networks and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice user (e.g., a mobile communications user data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Server 140 may include but is not limited to, for example, server 140 or cluster of computing devices in a first location and a second computing device or cluster of computing devices in a second location. Server 140 may include one or more computing devices dedicated to data storage, security, distribution of traffic for load balancing, and the like. Server 140 may distribute one or more computing tasks as described below across a plurality of computing devices of computing device, which may operate in parallel, in series, redundantly, or in any other manner used for distribution of tasks or memory between computing devices. Server 140 may be implemented using a “shared nothing” architecture in which data is cached at the worker, in an embodiment, this may enable scalability of system 100 and/or computing device 104.

Continuing to refer to FIG. 1, server 140 may be configured to communicate with a carrier device 120. Carrier device 120 may include a mobile device, desktop device, or other terminal device permitting a client to interact with computing device 104 and/or server 140 including without limitation by operation of a web browser or native application instantiating one or more user interfaces as directed, for instance, by server-side and/or client-side programs provided by server 140 in the form of a “website” or similar network-based application or suite of applications. Carrier device 120 may include, without limitation, a display in communication with server 140; the display may include any display as described in the entirety of this disclosure such as a light emitting diode (LED) screen, liquid crystal display (LCD), organic LED, cathode ray tube (CRT), touch screen, or any combination thereof. Output data from server 140 may be configured to be displayed on carrier device 120 using an output graphical user interface. An output graphical user interface may display any output as described in the entirety of this disclosure. Computing device 104 may be configured to receive a plurality of communications from carrier device 120. The “plurality of communications” as described herein, is data detailing the request items from the client to the supplier. An item can include any product a supplier may sell, without limitation. For example and without limitation, each communication of the plurality of communications may include a purchase order from the user to the supplier. Each communication of the plurality of communications may include, as an example and without limitation, information detailing the type of item, quantity of the item, agreed upon price of the item, anticipated deliver sate, any combination thereof, and/or the like. Persons skilled in the art, upon reviewing the entirety of this disclosure, will be aware of various communications that may be employed as the plurality of communications as described herein.

With continued reference to FIG. 1, server 140 may be configured to receive a carrier request 124 from carrier device 120. In some embodiments, server 140 may be configured to receive a plurality of carrier requests from a plurality of carrier devices. Carrier request 124 may include information about a type of transport unit, a quantity of items to be transported, and a location for a transport. Carrier request 124 may include a date and/or time for a transport. Server 140 may be configured to process carrier request 124. In some embodiments, server 140 may be configured to relay carrier request 124 to computing device 104. Computing device 104 may send carrier request 124 to transport optimizer 112. Transport optimizer 112 may be configured to output a transport request 128 based on provider resource datum 108 and carrier request 124. In some embodiments, computing device 104 may be configured to send transport request 128 to provider device 132. Transport request 128 may include a compilation of data detailing each communication of the plurality of communications and the associated plurality of items to be transported to a destination location by a carrier. Transport request 128 may be manually created by computing device 104 and/or automatically created utilizing system 100 and/or server 140 as described below. The transport request may include a confirmation by the computing device 104 to initiate transport request 128. In an embodiment, without limitation, receiving the transport request 128 on provider device 132 may include the provider at provider device 132 selecting an icon, entering a textual string of data, selecting a text box, verbally confirming, and the like. Transport request 128 may include data about a transport unit type, a quantity of transport units, a transport location, transport items, transport date, and transport times. Transport request 128 may be optimized by transport optimizer 112. Optimization of transport request 128 may include optimizing a transport date, transport time, transport unit type, quantity of transport units, and transport routes. Transport request 128 may be received on a provider device 132. Provider device 132 may include a mobile device, desktop device, or other terminal device permitting a client to interact with computing device 104 and/or server 140 including without limitation by operation of a web browser or native application instantiating one or more user interfaces as directed, for instance, by server-side and/or client-side programs provided by server 140 in the form of a “website” or similar network-based application or suite of applications. Provider device 132 may include, without limitation, a display in communication with server 140; the display may include any display as described in the entirety of this disclosure such as a light emitting diode (LED) screen, liquid crystal display (LCD), organic LED, cathode ray tube (CRT), touch screen, or any combination thereof. Output data from server 140 may be configured to be displayed on provider device 132 using an output graphical user interface. An output graphical user interface may display any output as described in the entirety of this disclosure. Computing device 104 may be configured to receive a plurality of communications from provider device 132. The “plurality of communications” as described herein, is data detailing the request items from the carrier to the supplier. An item can include any product a supplier may sell, without limitation. For example and without limitation, each communication of the plurality of communications may include a purchase order from the user to the supplier. Each communication of the plurality of communications may include, as an example and without limitation, information detailing the type of item, quantity of the item, agreed upon price of the item, anticipated deliver sate, any combination thereof, and/or the like. Persons skilled in the art, upon reviewing the entirety of this disclosure, will be aware of various communications that may be employed as the plurality of communications as described herein.

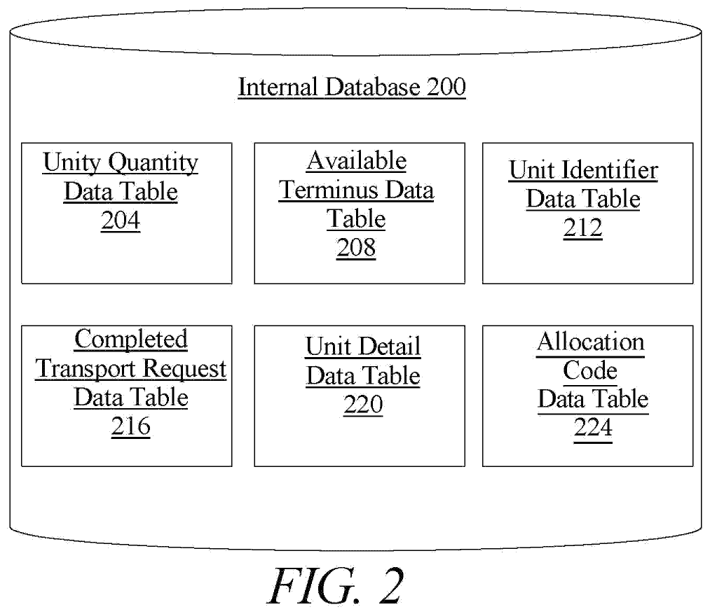

Still referring to FIG. 1, in some embodiments, provider device 132 may be configured to send an electronic acknowledgement 136 to server 140. Electronic acknowledgement 136 may include data regarding an approval of carrier request 124. In some embodiments, electronic acknowledgement 136 may include a digital signature. In some embodiments, electronic acknowledgement 136 may include an approval from a provider that carrier request 124 may be implemented. In some embodiments, electronic acknowledgement 136 may be sent to server 140 from provider device 132. In some embodiments, a plurality of electronic acknowledgements may be sent to server 140. Server 140 may process electronic acknowledgement 132. In some embodiments, server 140 may send electronic acknowledgement 132 to internal database 148 of computing device 104. In some embodiments, electronic acknowledgement 132 may include a verification datum. In some embodiments, generating a verification datum may include receiving the user submission from provider device 132, storing a completed transport request 128 in internal database 148, and transmitting a verification datum to provider device 132. The “user submission” as used herein, is a confirmation by the user and/or provider device 132 to complete transport request 128, wherein completion of transport request 128 signifies each selected communication of transport request 128 is ready to be transported. Receiving the user submission from provider device 132 may include any means, process, and/or method of receiving as described in the entirety of this disclosure. In an embodiment, without limitation, receiving the user submission from provider device 132 may include the user at provider device 132 selecting an icon, entering a textual string of data, selecting a text box, verbally confirming, and the like. For example and without limitation, receiving the user submission from provider device 132 may include the user at provider device 132 selecting a text box labeled “Submit”. Persons skilled in the art, upon reviewing the entirety of this disclosure, will be aware of various means of confirmation that may be employed as the user submission received from provider device 132 as described herein. The “completed transport request” as used herein, is transport request 128 at the time the user submission is received from user and/or provider device 132, wherein the transport request may include any data and/or datum input in transport request 128 as described above in further detail. The completed transport request may be generated as a function of receiving the user submission datum from provider device 132. The completed transport request can be stored in internal database 148. The completed transport request 128 may be stored in any suitable data and/or data type. For instance and without limitation, the completed transport request 128 may include textual data, such as numerical, character, and/or string data. Internal database 148 may include any internal database as described in further detail below in reference to FIG. 2. Persons skilled in the art, upon reviewing the entirety of this disclosure, will be aware of various methods of storing that may be employed with the completed transport request 128 as described herein. The “verification datum” as described herein, is a unique identifier associated to the completed transport request 128, wherein the unique identifier may include any alpha-numeric character. In an embodiment, the verification datum may include any number of characters in any arrangement. In an embodiment and without limitation, the verification datum can be used as a reference to locate the completes transport request 128 within system 100 and/or server 140. For example and without limitation, the verification datum may include a unique identifier associated to the completed transport request 128, such as “A100-0038001”. Transmitting verification datum to provider device 132 may include any means of transmission as described in the entirety of this disclosure. In an embodiment and without limitation, transmission of verification datum to provider device 132 may include a push notification, an email, a textual display, and/or the like. For example and without limitation, transmission of verification datum may include a push notification including a textual display of “E2200-001”. Persons skilled in the art, upon reviewing the entirety of this disclosure, will be aware of various means of transmission that may be employed as the verification datum transmitted to provider device 132 as described herein. In some embodiments, the generation of a verification datum may be that as described in U.S. patent application Ser. No. 17/072,743, filed Oct. 16, 2020, titled “METHODS AND SYSTEMS FOR SCHEDULING A USER TRANSPORT”, of which is incorporated herein by reference in its entirety.

In some embodiments, and with continued reference to FIG. 1, computing device 104 may include an internal database 148. Internal database 148 may be implemented as any database and/or datastore suitable for use as internal database 148 as described in the entirety of this disclosure. Computing device 104 may be configured to store each communication of the plurality of communications received from carrier device 120 in internal database 148. Storing may include any means of storing as described in the entirety of this disclosure. Persons skilled in the art, upon reviewing the entirety of this disclosure, will be aware of various examples of the plurality of communications that may be stored in the internal database consistently with this disclosure. In some embodiments, internal database 148 may store carrier datums, provider datums, and/or transport datums.

In some embodiments, and with continued reference to FIG. 1, computing device 104 may process carrier request 124 automatically. In other embodiments, computing device 104 may include a manual override. In some embodiments, the manual override may be used to correct erroneous request and/or transport information. In some embodiments, the data of provider resource datum 108 may include a ready datum of a transport. The ready datum may include data about a status of a transport unit. The status may be an availability or ready status. The ready status may be determined by a plurality of factors. In some embodiments, the status of the transport may include data about the components secured in a transport carrier. In some embodiments, the status may be determined by a fuel measurement of a transport unit of a provider. In some embodiments, the ready status may include inventory data of a provider. The inventory data of the provider may include data about one or more transport units. The one or more transport units may be configured to reside in a holding unit. In some embodiments, the ready datum may include data describing the date the carrier and/or carrier device 124 plans to execute transport request 128, such that each communication of the plurality of communications is fulfilled by each item of the plurality of items being delivered to the destination location as detailed in the associated terminus data of each communication.

With continued reference to FIG. 1, computing device 104 may communicate with a provider through provider device 132. The provider may include a holding unit having a plurality of a variety of components. The provider may have one or more transport units that may be configured to transport one or more components to a destination. In some embodiments, the provider may include a variety of transport unit types. In some embodiments, the transport units may include, but are not limited to, trucks, cars, ships, drones, planes, helicopters, or other transport units. In some embodiments, the provider may have multiple housing units. In some embodiments, the multiple housing units may have one transportation unit type per house. In other embodiments, a variety of transportation units may be included in the multiple housings. In some embodiments, the provider may include a warehouse. In some embodiments, the warehouse may include, but is not limited to, a public warehouse, a private warehouse, a climate-controlled warehouse, an automated warehouse, a distribution center, a smart warehouse, and a bonded warehouse. In some embodiments, the provider may include a component storage unit. In some embodiments, the component storage unit may be positioned within a housing unit. In some embodiments, the component storage unit may include construction materials. In other embodiments, the component storage unit may include consumer products. In other embodiments, the component storage unit may include electronics and electronic materials. In other embodiments, the component storage unit may include foodstuffs. In some embodiments, the provider may have a plurality of sensors in the housing unit. In some embodiments, the plurality of sensors may be configured to detect a quantity of components. In other embodiments, the plurality of sensor may be configured to detect a location of a component. In other embodiments, the plurality of sensors may be configured to detect a position of a transport unit. In some embodiments, the plurality of sensors may be configured to detect an availability in a space of a housing unit for an incoming transport unit. In some embodiments, the plurality of sensors may be configured to detect temperature of a housing unit. In some embodiments, the plurality of sensors may be configured to detect temperature of a transport unit.

With continued reference to FIG. 1, computing device 104 may be configured to include a transport optimizer 112. Transport optimizer 112 may be configured to optimize a transport of one or more transport units. Computing device 104 may store, verify, or otherwise process electronic acknowledgement 136 and send it to transport optimizer 112. Transport optimizer 112 may be configured to update a provider data table 144 based on electronic acknowledgement 136 of transport request 128. Optimization may include, without limitation, initially sorting carriers and routes and/or orders associated therewith into related groups and generating pairings within groups. Sorting may be based at least partially on geographic data of carriers and orders and/or routes, such as current locations and/or geographic regions, such as rectangular sections of given area, which may form a grid on a map. Proximity of current locations of carriers and provider locations may be used to divide orders and/or routes and active carriers into sorted groups. For example, provider locations corresponding to orders may be grouped by sub-region. In some embodiments, sub-regions may be arbitrarily selected. Alternatively or additionally, orders and/or routes and couriers may be grouped by other factors, such as regional boundaries like freeways, rivers, neighborhood boundaries, or the like. For example, providers corresponding to the created orders may be grouped into sub-regions defined by roads such that the sub-regions may correspond to recognized neighborhoods. Other factors for sorting carriers and orders and/or routes include historical courier data which may indicate familiarity with particular areas. For example, a carrier that has picked up orders from a particular area or provider may be grouped with a set of orders from such region and/or provider, even if another courier is closer in geographic proximity to an order pickup location of provider. In some embodiments, transport optimizer 112 may include generation of objective function. Generation of an objective function may include generation of a function to score and weight factors to achieve a route score for each feasible pairing. In some embodiments, pairings may be scored in a matrix for optimization, where columns represent routes and rows represent couriers potentially paired therewith; each cell of such a matrix may represent a score of a pairing of the corresponding route to the corresponding courier.

With continued reference to FIG. 1, transport optimizer 112 may generate an objective function that may include performing a greedy algorithm process. A “greedy algorithm” is defined as an algorithm that selects locally optimal choices, which may or may not generate a globally optimal solution. For instance, computing device 104 may select pairings so that scores associated therewith are the best score for each order and/or for each carrier. In such an example, optimization may determine the combination of routes such that each delivery pairing includes the highest score possible. The objective function may be formulated as a linear objective function. Transport optimizer 112 may solve an objective function using a linear program such as without limitation a mixed-integer program. A “linear program,” as used in this disclosure, is a program that optimizes a linear objective function, given at least a constraint. For instance, and without limitation, objective function may seek to maximize a total score Σr∈R Σs∈S cᵣₛxᵣₛ, where R is the set of all routes r, S is a set of all carriers s, cᵣₛ is a score of a pairing of a given route with a given carrier, and xᵣₛ is 1 if a route r is paired with carrier s, and 0 otherwise. Continuing the example, constraints may specify that each route is assigned to only one carrier, and each carrier is assigned only one route; routes may include compound routes as described above. Sets of routes may be optimized for a maximum score combination of all generated routes. In various embodiments, transport optimizer 112 may determine combination of routes that maximizes a total score subject to a constraint that all deliveries are paired to exactly one carrier. Not all carriers may receive a route pairing since each delivery may only be delivered by one carrier. A mathematical solver may be implemented to solve for the set of feasible pairings that maximizes the sum of scores across all pairings; mathematical solver may be implemented in transport optimizer 112 and/or another device in system 100, and/or may be implemented on third-party solver.

Still referring to FIG. 1, transport optimizer 112 may be configured to optimize an objective function. The objective function may include minimizing a loss function, where a “loss function” is an expression an output of which an optimization algorithm minimizes to generate an optimal result. As a non-limiting example, computing device 104 may assign variables relating to a set of parameters, which may correspond to score components as described above, calculate an output of mathematical expression using the variables, and select a pairing that produces an output having the lowest size, according to a given definition of “size,” of the set of outputs representing each of plurality of candidate ingredient combinations; size may, for instance, included absolute value, numerical size, or the like. Selection of different loss functions may result in identification of different potential pairings as generating minimal outputs. Objectives represented in an objective function and/or loss function may include minimization of delivery times. Objectives may include minimization of wait times by couriers at providers; wait times may depend, for instance and without limitation, on assembly times as described above. Objectives may include minimization of times delivery times in excess of estimated or requested arrival times.

With continued reference to FIG. 1, transport optimizer 112 may include a machine learning model. The machine learning model may be trained on training data 116. Training data 116 may include a plurality of transport data. The plurality of transport data may include a history of transports. In some embodiments, the plurality of transport data may include transport unit dimensions, transport unit fuel, transport unit speed, dimensions and weight of transport items and/or cargo. In some embodiments, the transport data may include transport routes and times. In some embodiments, the transport data may include transport locations. In some embodiments, transport optimizer 112 may be configured to output an optimized data table 144 for a provider. Provider data table 144 may be configured to include an output of transport optimizer 112. Provider data table 144 may include data about a status of one or more transport units. Provider data table 144 may include a status about one or more components in transit of a transport unit. Provider data table 144 may include a status about availability of one or more transport units. Provider data table 144 may include, but is not limited to, data on upcoming, previous, pending, and/or canceled carrier requests 124. In some embodiments, provider data table 144 may include planned transport routes. In some embodiments, provider data table 144 may include data on departure and arrival times of a transport. In some embodiments, provider data table 144 may be color coded. The color code of provider data table 144 may be configured to match a type of transport unit to a specific color. In some embodiments, the color code of provider data table 144 may be configured to match a type of component being transported. In some embodiments, the color code of provider data table 144 may be configured to match a specific carrier to a transport unit. In some embodiments, provider data table 144 may be include time slots. In some embodiments, provider data table 144 may include a calendar. In some embodiments, provider data table 144 may be updated in real time. In some embodiments, provider data table 144 may organize transport units and components of transports for a provider. In some embodiments, provider data table 144 may include data of incoming resource transports. In some embodiments, provider data table 144 may include data about an availability of a specific type of transport unit. In some embodiments, provider data table 144 may include data about a location of one or more transport units. In some embodiments, provider data table 144 may include a search datum. In some embodiments, the search datum may be configured to allow a user to search any transport unit and associated components by a number of data associated with a transport unit. Search datum may include data of a name of a transport unit. Search datum may include a component type of a transport. Search datum may include a time period associated with a transport. Search datum may include provider and/or carrier name of a transport. In some embodiments, provider data table 144 may be configured to automatically block off a time period of a transport based on the length of the transport time. Provider data table 144 may be configured to display transport information. In some embodiments, provider data table 144 may be configured to display transport types, transport costs, transport destinations, components of a transport, receiver of a transport, and time period of a transport. In some embodiments, provider data table 144 may be configured to display transports incoming to a provider housing unit. In some embodiments, provider data table 144 may be configured to display incoming transport types, weights, measurements, departure times, arrival times, components transported, and costs of transport.

Referring now to FIG. 2, an embodiment of internal database 200 is illustrated. Internal database 200 may include any data structure for ordered storage and retrieval of data, which may be implemented as a hardware or software module. Internal database 200 may be implemented, without limitation, as a relational database, a key-value retrieval datastore such as a NOSQL database, or any other format or structure for use as a datastore that a person skilled in the art would recognize as suitable upon review of the entirety of this disclosure. Internal database 200 may include a plurality of data entries and/or records corresponding to elements as described above. Data entries and/or records may describe, without limitation, data concerning the plurality of communications, associated terminus datum, unit identifier datum, completed transport request data, unit detail datum, and allocation code data.

Still referring to FIG. 2, one or more database tables in internal database 200 may include, as a non-limiting example, a unit quantity data table 204. Unit quantity data table 204 may include a table storing unit quantities of a provider. In some embodiments, internal database 200 may include a plurality of unit quantity data tables 204 listing each unit quantity. Unit quantity data table 204 may include a unit quantity datum. A “unit quantity datum” as described herein, is the quantity of each item of the plurality of items included in each communication of the plurality of communications. The unit quantity datum, in an embodiment, can include any numeric value. For example and without limitation, the unit quantity datum may include a quantity of “5”, “25”, “125” and the like. In an embodiment, there is no limitation to the number of unit quantity datum included in each communication of the plurality of communication received from client device 108. Persons skilled in the art, upon reviewing the entirety of this disclosure, will be aware of various numeric values that may be used as the unit quantity datum consistently with this disclosure.

Continuing to refer to FIG. 2, one or more database tables in internal database 200 may include, as a non-limiting example, an available terminus data table 208. Available terminus data table 208 may be a table storing an associated terminus datum generated by server 140 as a function of processing each communication of the plurality of communications received from carrier device 120. For instance, and without limitation, internal database 200 may include an available terminus data table 208 listing the associated terminus datum generated by server 140 as a function of processing each communication of the plurality of communications received from client device 124, such as “Magnum Warehousing 1301 39^{th} Street N Fargo, N. Dak. 58102”. The “associated terminus datum” as described herein, is the final destination of each communication of the plurality of communications. In an embodiment, for example and without limitation, the final destination may include the details of a physical location, such as an address, coordinates, a unique identifier correlating to a physical location, and/or the like. For example and without limitation, the final destination may include “Magnus Warehousing 1301 39^{th} Street N Fargo, N. Dak. 58102”. Persons skilled in the art, upon reviewing the entirety of this disclosure, will be aware of various examples of physical locations that may be used as the associated terminus datum consistently with this disclosure.

With continued reference to FIG. 2, one or more database tables in internal database 200 may include, as a non-limiting example, an unit identifier data table 212. Unit identifier data table 208 may be a table storing a unit identifier datum generated by server 140 as a function of processing each communication of the plurality of communications received from carrier device 120. For instance, and without limitation, internal database 200 may include a unit identifier datum listing an unit identifier datum generated by the server 140 as a function of processing each communication of the plurality of communications received from carrier device 120, such as the unique identifier of “N303363”, “K994002”, “F110482”, and the like. The “unit identifier datum” as described herein, is a unique identifier associated with each item of the plurality of items included in each communication of the plurality of communication received from carrier device 120. In an embodiment, the unique identifier may include any combination of alpha and/or numerical values, wherein there may be any total of values included in the unique identifier. Each unique identifier of the unit identifier datum is associated with an item able to be transmitted from the supplier to a destination. For example and without limitation, unit identifier datum may include the unique identifier of a combination of seven alpha and/or numeric values, such as “N303363”, “K994002”, “F110482”, “AKK13257”, and the like. In an embodiment, there is no limitation to the number of unit identifier datum included in each communication of the plurality of communication. Persons skilled in the art, upon reviewing the entirety of this disclosure, will be aware of various examples of unique identifiers that may be used as the unit identifier datum consistently with this disclosure.

Still referring to FIG. 2, one or more database tables in internal database 200 may include, as a non-limiting example, a completed transport request data table 216. Completed transport request data table 216 may include a table storing the completed transport request 128 initiated by server 140 as a function of the carrier request 124 received from carrier device 120. For instance, and without limitation, internal database 200 may include a completed transport request data table 216 listing a completed transport request 128 generated by server 140 as a function of the carrier request 124 received from carrier device 120. The completed transport request 128 may include any completed transport request 128 as described in the entirety of this disclosure.

Continuing to refer to FIG. 2, one or more database tables in internal database 200 may include, as a non-limiting example, a unit detail data table 220. Unit detail data table 220 may include a table storing the unit detail datum generated by server 140 as a function of processing each communication of the plurality of communications received from carrier device 120. A “unit detail datum” as described herein, is the textual identifier detailing a description of each item of the plurality of items included in each communication of the plurality of communications. In an embodiment, without limitation, the unit detail datum may include the technical name of an item, the use of an item, the size of the item, functional location of the item, advertising name for an item, any combination thereof, and/or the like. For example and without limitation, the unit detail datum may include brief descriptions, such as “Bracket, Cab Support”, “Bracket, Front Right Bulkhead”, “Angle, Platform”, “Flange”, “323E Track—Z-Lug”, “42 in. Mower Blade”, to name a few. In an embodiment, the number of unit detail datums included within each communication of the plurality of communication correlated directly to the number of the unit identifier datums included in each communication of the plurality of communications, however there is no limitation as to the quantity of the unit detail datum included in each communication of the plurality of communications. Persons skilled in the art, upon reviewing the entirety of this disclosure, will be aware of various examples of descriptions of items that may be used as the unit detail datum consistently with this disclosure For instance, and without limitation, internal database 200 may include an unit detail datum table 216 listing an unit detail datum generated by server 140 as a function of processing each communication of the plurality of communications received from carrier device 120, such as the brief description of “Bracket, Front Right Bulkhead”.

With continued reference to FIG. 2, one or more database tables in internal database 200 may include, as a non-limiting example, an allocation code data table 224. Allocation code data table 224 may include a table storing the allocation code. The allocation code may be received from a carrier device 120. The “allocation code” as described herein, is a strong of alphanumeric characters assigned to each billing account associated with a carrier and/or carrier device 120. In an embodiment without limitation, the allocation code ensures the cost associated with transport request 128 is associated to the proper billing account of the client and/or client device. For example and without limitation, the allocation code may include a four-character identifier, such that one client and/or client device 108 has allocation codes corresponding to their warehouse locations, wherein the allocation codes include “9M00”, “9M01”, “9M02”, “9M03”, “9M04” and “9M05”. As a further example and without limitation, the allocation code may include a three-character identifier, such that one client and/or client device 108 has allocation codes responding to the item type, wherein the allocation codes include “77A”, “77B”. “77C” “77D” and “77E”. The allocation code may be stored in and/or retrieved from internal database 200.

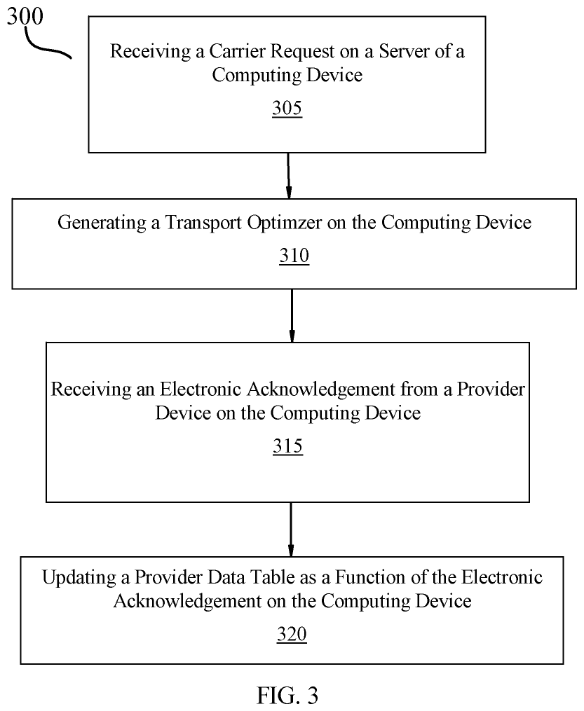

FIG. 3 illustrates an exemplary embodiment of a method 300 of generating a data table of transports for a provider. At step 305, a carrier request is received on a server of a computing device. The carrier request may include a transport datum of at least one transport. In some embodiments, the carrier request may include information about one or more components of a transport. In some embodiments, the data may include information about a weight of the transport. In some embodiments, the data may include information about measurements of a transport. In some embodiments, the status may include data about transport unit fuel. In some embodiments, the status may include data about transport unit routes. In some embodiments, carrier request 104 may include data about a departure and arrival time of a transport unit. In some embodiments, carrier request 104 may include data about multiple transport units having multiple components. In some embodiments, carrier request 104 may include destination data. In some embodiments, carrier request 104 may include a cost estimate of transporting components to a destination via a transport unit. In some embodiments, carrier request 104 may include data about a type of transportation unit required. In some embodiments, transportation units may include, but are not limited to, ships, trucks, planes, drones, or other transportation units.

At step 310, and still referring to FIG. 3, a transport optimizer is generated on the computing device. In some embodiments, the transport optimizer includes a machine learning model. The machine learning model may be trained using training data include a plurality of transport datum and provider resource datum. The machine learning module may be responsive to the training and provide a transport request as a function of the carrier request and provider resource datum. The transport request may include a transport time corresponding to the carrier request. In some embodiments, the transport optimizer may be configured to optimize a transport route of a transport unit. In some embodiments, the transport optimizer may be configured to optimize an allocation of resources and transport components of a provider. In some embodiments, the machine learning module may include a supervised machine learning module. In other embodiments, the machine learning module may be unsupervised. In some embodiments, the transport optimizer may process the carrier request and provide an output including, but not limited to, optimal time, component, transport type, and destination data for the provider. The transport optimizer may generate a procedure for a provider to efficiently transport components to various carriers based on transport history of those various carriers. In some embodiments, the transport optimizer, may set up reoccurring transports to a carrier from a provider based on transport history of the carrier. In some embodiments, the transport optimizer may set up reoccurring transports to a carrier based on resource data of the provider and/or carrier. The transport optimizer may be configured to send push notifications to a carrier and/or provider about upcoming transports, completed transports, pending transports, and/or canceled transports.

At step 315 and still referring to FIG. 3, an electronic acknowledgement from a provider is received. In some embodiments, the electronic acknowledgement is received on a computing device. In some embodiments, the electronic acknowledgement includes a communication from a computing device of a provider acknowledging a transport time of a transport unit is confirmed by the provider. The electronic acknowledgement may include data about a transport request of a carrier. The data about a transport request of a carrier may include, but is not limited to, transport type, component type, destination, arrival time, departure time, and fuel. The electronic acknowledgement may include data about a provider's resources and available transport units. In some embodiments, the electronic acknowledgement may include a digital signature.

At step 320 and still referring to FIG. 3, a provider data table is updated as a function of the electronic acknowledgement on the computing device. In some embodiments, the provider data table may include a table of confirmed transports and resource status datums for a provider. In some embodiments, the provider data table may be updated in real time. In other embodiments, the provider data table may be updated in time intervals. In some embodiments, the provider data table may include data on upcoming, previous, pending, and/or canceled carrier requests. In some embodiments, the data table may include planned transport routes. In some embodiments, the data table may include data on departure and arrival times of a transport. In some embodiments, the data table may be color coded. The color code of the data table may be configured to match a type of transport unit to a specific color. In some embodiments, the color code of the data table may be configured to match a type of component being transported. In some embodiments, the color code of the data table may be configured to match a specific carrier to a transport unit. In some embodiments, the data table may include available and/or unavailable time slots. In some embodiments, the data table may include a calendar. In some embodiments, the data table may be updated in real time. In some embodiments, the data table may organize transport units and components of transports for provider. In some embodiments, the data table may include data of incoming resource transports. In some embodiments, the data table may include data about an availability of a specific type of transport unit. In some embodiments, the data table may include data about a location of one or more transport units. In some embodiments, the data table may be updated from the transport optimizer. In some embodiments, the data table may be updated to display a resource efficient schedule.

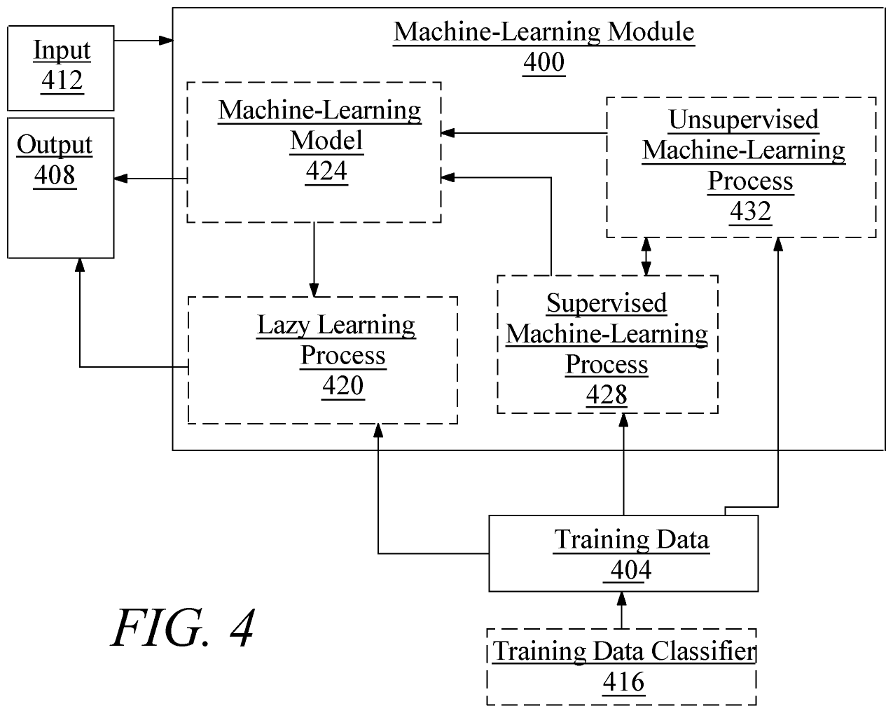

Referring now to FIG. 4, an exemplary embodiment of a machine-learning module 400 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 404 to generate an algorithm that will be performed by a computing device/module to produce outputs 408 given data provided as inputs 412; this is in contrast to a non-machine learning software program where the commands to be executed are determined in advance by a user and written in a programming language.

Still referring to FIG. 4, “training data,” as used herein, is data containing correlations that a machine-learning process may use to model relationships between two or more categories of data elements. For instance, and without limitation, training data 404 may include a plurality of data entries, each entry representing a set of data elements that were recorded, received, and/or generated together; data elements may be correlated by shared existence in a given data entry, by proximity in a given data entry, or the like. Multiple data entries in training data 404 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 404 according to various correlations; correlations may indicate causative and/or predictive links between categories of data elements, which may be modeled as relationships such as mathematical relationships by machine-learning processes as described in further detail below. Training data 404 may be formatted and/or organized by categories of data elements, for instance by associating data elements with one or more descriptors corresponding to categories of data elements. As a non-limiting example, training data 404 may include data entered in standardized forms by persons or processes, such that entry of a given data element in a given field in a form may be mapped to one or more descriptors of categories. Elements in training data 404 may be linked to descriptors of categories by tags, tokens, or other data elements; for instance, and without limitation, training data 404 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 4, training data 404 may include one or more elements that are not categorized; that is, training data 404 may not be formatted or contain descriptors for some elements of data. Machine-learning algorithms and/or other processes may sort training data 404 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 404 to be made applicable for two or more distinct machine-learning algorithms as described in further detail below. Training data 404 used by machine-learning module 400 may correlate any input data as described in this disclosure to any output data as described in this disclosure.

Further referring to FIG. 4, training data may be filtered, sorted, and/or selected using one or more supervised and/or unsupervised machine-learning processes and/or models as described in further detail below; such models may include without limitation a training data classifier 416. Training data classifier 416 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 400 may generate a classifier using a classification algorithm, defined as a processes whereby a computing device and/or any module and/or component operating thereon derives a classifier from training data 404. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers.

Still referring to FIG. 4, machine-learning module 400 may be configured to perform a lazy-learning process 420 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 404. Heuristic may include selecting some number of highest-ranking associations and/or training data 404 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 4, machine-learning processes as described in this disclosure may be used to generate machine-learning models 424. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 424 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 424 may be generated by creating an artificial neural network, such as a convolutional neural network comprising an input layer of nodes, one or more intermediate layers, and an output layer of nodes. Connections between nodes may be created via the process of “training” the network, in which elements from a training data 404 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 4, machine-learning algorithms may include at least a supervised machine-learning process 428. At least a supervised machine-learning process 428, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include inputs and outputs as described above in this disclosure, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 404. Persons skilled in the art, upon reviewing the entirety of this disclosure, will be aware of various possible variations of at least a supervised machine-learning process 428 that may be used to determine relation between inputs and outputs. Supervised machine-learning processes may include classification algorithms as defined above.

Further referring to FIG. 4, machine learning processes may include at least an unsupervised machine-learning processes 432. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 4, machine-learning module 400 may be designed and configured to create a machine-learning model 424 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 4, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

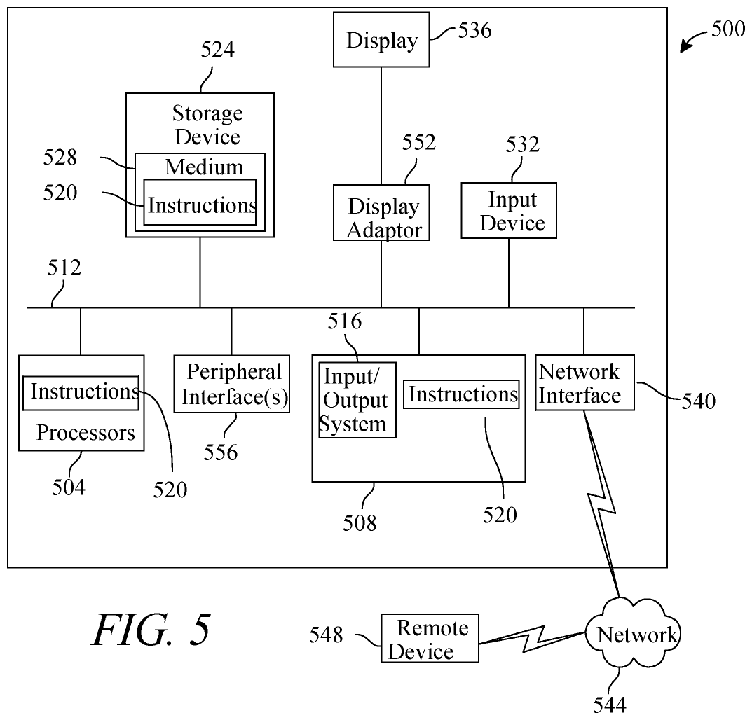

FIG. 5 shows a diagrammatic representation of one embodiment of a computing device in the exemplary form of a computer system 500 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 500 includes a processor 504 and a memory 508 that communicate with each other, and with other components, via a bus 512. Bus 512 may include any of several types of bus structures including, but not limited to, a memory bus, a memory controller, a peripheral bus, a local bus, and any combinations thereof, using any of a variety of bus architectures.

Processor 504 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 504 may be organized according to Von Neumann and/or Harvard architecture as a non-limiting example. Processor 504 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 508 may include various components (e.g., machine-readable media) including, but not limited to, a random-access memory component, a read only component, and any combinations thereof. In one example, a basic input/output system 516 (BIOS), including basic routines that help to transfer information between elements within computer system 500, such as during start-up, may be stored in memory 508. Memory 508 may also include (e.g., stored on one or more machine-readable media) instructions (e.g., software) 520 embodying any one or more of the aspects and/or methodologies of the present disclosure. In another example, memory 508 may further include any number of program modules including, but not limited to, an operating system, one or more application programs, other program modules, program data, and any combinations thereof.

Computer system 500 may also include a storage device 524. Examples of a storage device (e.g., storage device 524) include, but are not limited to, a hard disk drive, a magnetic disk drive, an optical disc drive in combination with an optical medium, a solid-state memory device, and any combinations thereof. Storage device 524 may be connected to bus 512 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 524 (or one or more components thereof) may be removably interfaced with computer system 500 (e.g., via an external port connector (not shown)). Particularly, storage device 524 and an associated machine-readable medium 528 may provide nonvolatile and/or volatile storage of machine-readable instructions, data structures, program modules, and/or other data for computer system 500. In one example, software 520 may reside, completely or partially, within machine-readable medium 528. In another example, software 520 may reside, completely or partially, within processor 504.

Computer system 500 may also include an input device 532. In one example, a user of computer system 500 may enter commands and/or other information into computer system 500 via input device 532. Examples of an input device 532 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 532 may be interfaced to bus 512 via any of a variety of interfaces (not shown) including, but not limited to, a serial interface, a parallel interface, a game port, a USB interface, a FIREWIRE interface, a direct interface to bus 512, and any combinations thereof. Input device 532 may include a touch screen interface that may be a part of or separate from display 536, discussed further below. Input device 532 may be utilized as a user selection device for selecting one or more graphical representations in a graphical interface as described above.

A user may also input commands and/or other information to computer system 500 via storage device 524 (e.g., a removable disk drive, a flash drive, etc.) and/or network interface device 540. A network interface device, such as network interface device 540, may be utilized for connecting computer system 500 to one or more of a variety of networks, such as network 544, and one or more remote devices 548 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 544, may employ a wired and/or a wireless mode of communication. In general, any network topology may be used. Information (e.g., data, software 520, etc.) may be communicated to and/or from computer system 500 via network interface device 540.

Computer system 500 may further include a video display adapter 552 for communicating a displayable image to a display device, such as display device 536. Examples of a display device include, but are not limited to, a liquid crystal display (LCD), a cathode ray tube (CRT), a plasma display, a light emitting diode (LED) display, and any combinations thereof. Display adapter 552 and display device 536 may be utilized in combination with processor 504 to provide graphical representations of aspects of the present disclosure. In addition to a display device, computer system 500 may include one or more other peripheral output devices including, but not limited to, an audio speaker, a printer, and any combinations thereof. Such peripheral output devices may be connected to bus 512 via a peripheral interface 556. Examples of a peripheral interface include, but are not limited to, a serial port, a USB connection, a FIREWIRE connection, a parallel connection, and any combinations thereof.

1. A system for generating a data table of transports for a provider, the system comprising:
a computing device, wherein the computing device is configured to:
receive a carrier request on a server, wherein the carrier request includes a transport datum of at least one transport;
generate a machine learning model for a transport optimizer, wherein the machine learning model is configured to output a transport request, the transport request including a transport time corresponding to the carrier request, as a function of the carrier request and a provider resource datum, wherein generating the machine learning model further comprises:
receiving training data comprising a plurality of transport data and correlated provider resource data;
training the machine learning model using the training data and a machine-learning algorithm; and
generating the trained machine learning model using the transport datum and the provider resource datum;
output the transport request as a function of the transport optimizer and the carrier request, wherein outputting the transport request comprises:
providing the carrier request and the provider resource datum as inputs to the trained machine learning model; and
generating the transport request as an output of the trained machine learning model;
receive an electronic acknowledgement from the provider, wherein the electronic acknowledgement further comprises a verification datum associated to the transport request when the transport request is completed, and wherein the verification datum comprises at least a textual datum; and
update, by the transport optimizer, automatedly, a provider data table as a function of the electronic acknowledgement, wherein the provider data table includes a table of confirmed transports and resource status datums for the provider, wherein the provider data table includes at least a search datum configured to allow a user to search for a particular transport.

2. The system of claim 1, wherein the transport datum includes a ready datum of the at least one transport.

3. The system of claim 1, wherein the transport datum includes transport times and transport destinations.

4. The system of claim 1, wherein the transport datum includes a datum of amount and measurements of a plurality of components included in the at least one transport.

5. The system of claim 1, wherein the provider datum includes data of open time intervals for a plurality of transports.

6. The system of claim 1, wherein the provider datum includes data of a plurality of open holding units for transport media of the provider.

7. The system of claim 1, wherein the provider datum includes data describing measurements of a plurality of transport media.

8. The system of claim 1, wherein the server is configured to communicate between a provider computing device and a carrier computing device.

9. (canceled)

10. The system of claim 1, wherein the machine learning algorithm further comprises a supervised machine-learning algorithm.

11. A method for generating a data table of transports for a provider, comprising:
receiving a carrier request on a server of a computing device, wherein the carrier request includes a transport datum of at least one transport;
generating a machine learning model for a transport optimizer on the computing device, wherein the machine learning model is configured to output a transport request, wherein the transport request includes a transport time corresponding to the carrier request, as a function of the carrier request and a provider resource datum, and wherein generating the machine learning model further comprises:
receiving training data comprising a plurality of transport data and correlated provider resource data;
training the machine learning model using the training data and a machine-learning algorithm generated by the computing device; and
generating the trained machine learning model using the transport datum and the provider resource datum;
outputting the transport request as a function of the transport optimizer and the carrier request, wherein outputting the transport request comprises:
providing the carrier request and the provider resource datum as inputs to the trained machine learning model; and
generating the transport request as an output of the trained machine learning model;
receiving an electronic acknowledgement from the provider on the computing device, wherein the electronic acknowledgement further comprises a verification datum associated to the transport request when the transport request is completed and wherein the verification datum comprises at least a textual datum; and
updating, by the transport optimizer, automatedly, a provider data table as a function of the electronic acknowledgement on the computing device, wherein the provider data table includes a table of confirmed transports and resource status datums for the provider, wherein the provider data table includes at least a search datum configured to allow a user to search for a particular transport.

12. The method of claim 11, wherein the datum of the at least one transport includes a ready datum of the at least one transport.

13. The method of claim 11, wherein the datum of the at least one transport includes transport times and transport destinations.

14. The method of claim 11, wherein the datum of the at least one transport includes a datum of amount and measurements of a plurality of components included in the at least one transport.

15. The method of claim 11, wherein the provider datum includes data of open time intervals for a plurality of transports.

16. The method of claim 11, wherein the provider datum includes data of a plurality of open holding units for transport mediums of the provider.

17. The method of claim 11, wherein the provider datum includes data of measurements and weight of a plurality of transport mediums.

18. The method of claim 11, wherein the server is configured to communicate between a provider computing device and a carrier computing device.

19. (canceled)

20. The method of claim 11, wherein the machine learning algorithm further comprises a supervised machine-learning algorithm.
